(19) United States
(12) Patent Application Publication
(10) Pub. No.: US 2024/0028745 A1
(43) Pub. Date: Jan. 25, 2024

(54) SYSTEM AND METHOD FOR HUNT, INCIDENT RESPONSE, AND FORENSIC ACTIVITIES ON AN AGNOSTIC PLATFORM

(71) Applicant: Booz Allen Hamilton Inc., McLean, VA (US)

(72) Inventors: Hannah Davies, Clearfield, UT (US); Michael Saxton, O'Fallon, IL (US)

(73) Assignee: Booz Allen Hamilton Inc., McLean, VA (US)

(21) Appl. No.: 18/356,501

(22) Filed: Jul. 21, 2023

Related U.S. Application Data
(60) Provisional application No. 63/369,072, filed on Jul. 22, 2022.

(51) Int. Cl. G06F 21/57; G06F 21/55

(52) U.S. Cl. CPC G06F 21/577; G06F 21/554

(57) ABSTRACT

Exemplary systems and methods are directed to endpoint detection and response (EDR) in which a receiver receives streaming data from plural EDR platforms with vendor-specific data formats for the streaming data. An application programming interface converts the streaming data received from each EDR platform to a common data format. A detection engine analyzes the converted streaming data for attributes of malicious activity and generates an alert when malicious activity is detected. A graphical user interface filters and sorts the generated alerts based on at least one of a priority of addressing the malicious activity and a severity of harm caused by the malicious activity. The graphical user interface further generates an interactive display of the filtered and sorted alerts, where each alert includes an active or activatable link which when selected provides additional information obtained from one of the plural EDR platforms associated with the alert.

### RELATED APPLICATIONS

This application claims priority to U.S. Provisional Application 62/369,072 filed on Jul. 22, 2022, the content of which is incorporated by reference in its entirety.

### FIELD

The present disclosure relates to a system and method for end point detection and response.

### BACKGROUND

Endpoint Detection and Response (EDR) systems serve as a security hub for an organization's network and allow for real-time monitoring of security threats and risks. Endpoints and/or hosts are monitored through the collection and analysis of data resulting from the execution of various processes, data transfers, network connections, and other network activities. EDR relies rule-based operations which perform automated analysis for detecting and investigating suspicious and malicious activities on a network. The rules-based approach also enables automated response generation for controlling device and network operations based on an identified threat and automated notification of a responsible party or group when a network threat or breach is detected. As a result, EDR systems allow a network security team to detect and address security events more quickly.

EDR systems are configured for operation based on a vendor-specified data format and vendor-specified command and control structure. For this reason, EDR systems are deployed with a related API and UI so that a user can orchestrate system operation and host connections through dedicated interfaces. In some business arrangements, a large organization may have a need to monitor the traffic and activity of sub-networks associated with authorized clients. In this arrangement, the organization can be presented various network security issues such as (1) choosing between suspicious and/or malicious activity detection and visibility while attempting to handle budget constraints and increasing data sources; (2) dealing with large teams and various data ownership models leading to siloed visibility between architecture layer; and (3) dealing with disparate activity detection models and a lack common data standards which creates inequities within the security operations teams. These issues can make EDR operations such as detection, incident response, and forensic activities cumbersome and inefficient which leads to vulnerabilities across the entire network.

### SUMMARY

An exemplary system for end point detection and response (EDR) is disclosed, the system comprising: memory that stores programming code for executing a graphical user interface, an application programming interface, and a detection engine; a receiver configured to receive streaming data from plural EDR platforms, each EDR platform having a vendor-specific data format for the streaming data; and a processor configured to: execute the programming code for generating the graphical user interface, the application programming interface, and the detection engine; convert, by the application programming interface, the streaming data received from each EDR platform to a common data format; analyze, by the detection engine, the converted streaming data for attributes of malicious activity and generate an alert when malicious activity is detected; filter and sort, by the graphical user interface, the generated alerts based on at least one of a priority of addressing the malicious activity and a severity of harm caused by the malicious activity; and generate, by the graphical user interface, an interactive display of the filtered and sorted alerts, wherein each alert includes an active or activatable link which when selected provides additional information obtained from one of the plural EDR platforms associated with the alert.

An exemplary method for end point detection and response (EDR) is disclosed, the method comprising: storing, in memory of a computing system, programming code for executing a graphical user interface, an application programming interface, and a detection engine; receiving, by a receiver of the computing system, streaming data from a plurality of EDR platforms, each EDR platform having a vendor-specific data format for the streaming data; executing, by a processor of the computing system, the programming code for generating the graphical user interface, the application programming interface, and the detection engine; converting, by the application programing interface, the streaming data received from each EDR platform to a common data format; analyzing, by the detection engine, the converted streaming data for attributes of malicious activity and generate an alert when malicious activity is detected; filtering and sorting, by the graphical user interface, the generated alerts based on at least one of a priority of addressing the malicious activity and a severity of harm caused by the malicious activity; and generating, by the graphical user interface, an interactive display of the filtered and sorted alerts, wherein each alert includes an active or activatable link which when selected provides additional information obtained from one of the plural EDR platforms associated with the alert.

An exemplary computer readable medium storing program code for performing a method for end point detection and response (EDR) is disclosed, which when placed in communicable contact with a computing system the program code causing the computing system to perform operations comprising: storing, in memory of a computing system, programming code for executing a graphical user interface, an application programming interface, and a detection engine; receiving, by a receiver of the computing system, streaming data from plural EDR platforms, each EDR platform having a vendor-specific data format for the streaming data; executing, by a processor of the computing system, the programming code for generating the graphical user interface, the application programming interface, and the detection engine; converting, by the application programming interface, the streaming data received from each EDR platform to a common data format; analyzing, by the detection engine, the converted streaming data for attributes of malicious activity and generate an alert when malicious activity is detected; filtering and sorting, by the graphical user interface, the generated alerts based on at least one of a priority of addressing the malicious activity and a severity of harm caused by the malicious activity; and generating, by the graphical user interface, an interactive display of the filtered and sorted alerts, wherein each alert includes an active or activatable link which when selected provides additional information obtained from one of the plural EDR platforms associated with the alert.

### BRIEF DESCRIPTION OF THE DRAWINGS

Exemplary embodiments are best understood from the following detailed description when read in conjunction with the accompanying drawings. Included in the drawings are the following figures:

FIG. 1 illustrates an end point detection and response (EDR) system in accordance with an exemplary embodiment of the present disclosure.

FIGS. 2A-2J illustrates an exemplary arrangement of the UI 110 in accordance with an exemplary embodiment.

FIG. 3 illustrates a method for end point detection and response in accordance with an exemplary embodiment of the present disclosure.

FIG. 4 illustrates a block diagram of a hardware configuration of the computing device in accordance with an exemplary embodiment of the present disclosure.

Further areas of applicability of the present disclosure will become apparent from the detailed description provided hereinafter. It should be understood that the detailed descriptions of exemplary embodiments are intended for illustration purposes only and, therefore, are not intended to necessarily limit the scope of the disclosure.

### DETAILED DESCRIPTION

Exemplary embodiments of the present disclosure are directed to a system and method that provides an agnostic platform for conducting hunts for malicious activity, incident (e.g., security breach, network intrusion, intrusion attempt) response, and forensic activities related to cybersecurity operations. The agnostic platform described herein is configured to connect to EDR tools (e.g., platforms, management consoles) associated with different vendors through a common interface. The agnostic platform maps each EDR tool to a common data format and common command structure through an application programming interface so that communication, configuration, data analysis, and incident response can be conducted with any host or vendor platform so that a user manages several EDR tools through the single agnostic platform.

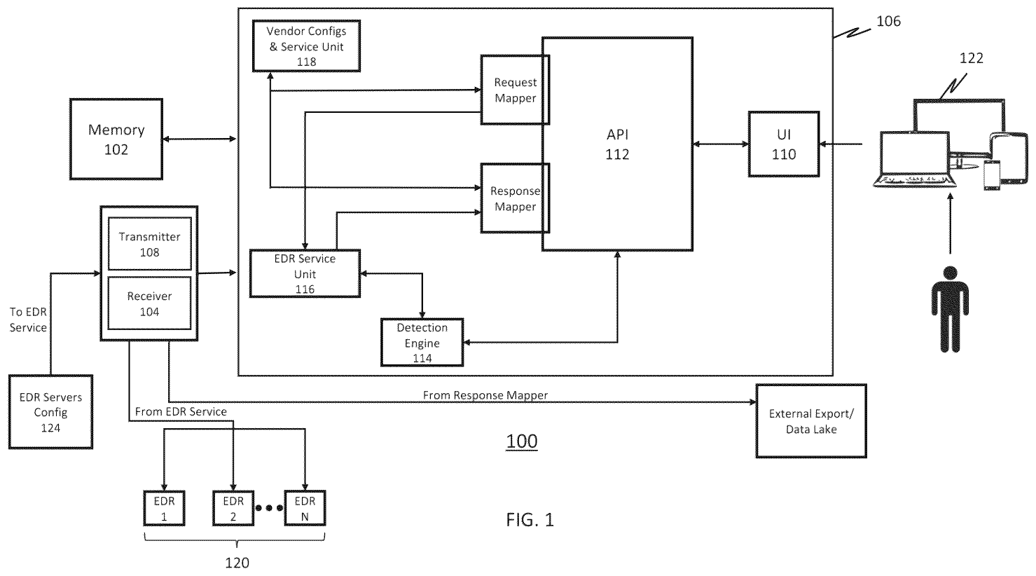

FIG. 1 illustrates an end point detection and response (EDR) system in accordance with an exemplary embodiment of the present disclosure.

As shown in FIG. 1, the EDR system 100 can be implemented in a processing or computing device having at least, memory 102, a receiver 104, a processor 106, and a transmitter 108. The memory 102 can be configured to store programming code for executing a graphical user interface (UI) 110, an application programming interface (API) 112, and a detection engine 114, an EDR Service (EDRS) Unit 116, and a Vendor Configuration & Service (VCS) Unit 118. The receiver 104 can be configured to receive streaming data from plural EDR platforms, where each EDR tool or platform has a vendor-specific command structure and data format for the streaming data. The processor 106 can be configured to execute the programming code for generating the agnostic platform which includes the UI 110, the API 112, and the detection engine 114.

The API 112 is configured as a singular API that performs all the necessary processing needed to seamlessly interact with multiple EDR tools 120 through the single agnostic platform. The EDR tools 120 operate as authorized Hypertext Transfer Protocol (HTTP) clients on the network, where at least two of the EDR tools can be associated with different vendors. By interacting with the EDR tools 120, the API 112 can also interact with the hosts and endpoints monitored by each respective EDR tool. The functionality and features of the API 112 can be accessed via the UI 110 at multiple endpoints 122 such as user computing devices (e.g., desktop computer, laptop computer, smart phone, tablet, or any other suitable computing or smart device as desired) which are connected to communicate with the processor 106 over a network. The multiple endpoints 122 in combination with the UI 110 can allow the user to query, add, or modify information on the platform and on EDR tools 120 with which the API 112 is configured to interact. For example, the API 112 can be configured to download data of interest from each of the configured EDR tools 120. The data of interest can include, for example, vendor information associated with and for use in the VCS unit 118, server and host information for use with the EDRS unit 116, and alerts and indicators of compromise (IOC) for use with the Detection Engine 114. In addition, the endpoints 122 can be used to add and/or modify IOCs, and create and/or manage active hunts for malicious activity, command line EDR emulator sessions, and queries for data from a vendor, host, and/or EDR tool 120.

According to an exemplary embodiment, the API 112 uses customized mappings and a data enrichment operation for the received streaming data so that the unique data formats of the different EDR tools 120 can be consolidated into a common data format (CDF). For example, the API 110 can be configured to convert streaming data received in a first format associated with a first EDR platform (EDR 1) to a second format associated with a second EDR platform (EDR 2). During this operation, the API 110 can convert the streaming data in the first format of the first EDR platform (EDR 1) to the common data format, and next convert the streaming data in the common data format to the second data format of the second EDR platform (EDR 2). A singular common data format reduces the complexity inherent in integrating multiple unique EDR tools 120 and provides a simplified end user experience.

The API 112 is highly flexible and extensible such that any EDR tool 120 with a sufficiently robust API could be easily integrated given that the vendor specific stream mappings and the configuration files are provided. The stream mappings and the configuration files allow the API 112 to map the vendor address to credentials and commands necessary to interact with a specified EDR tool 120.

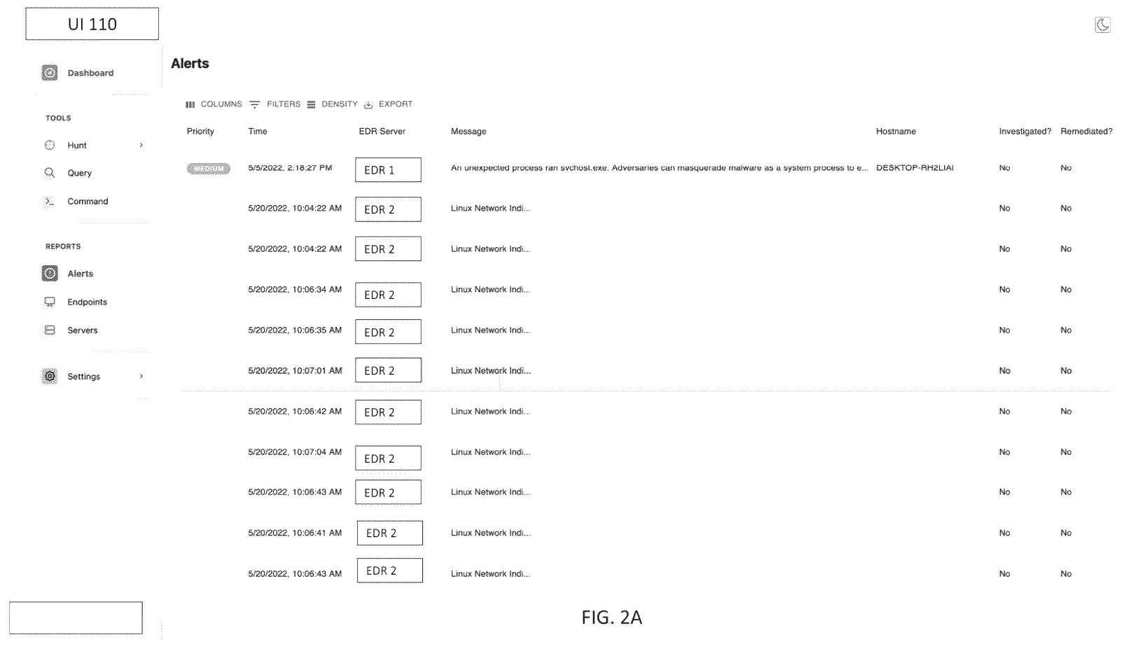

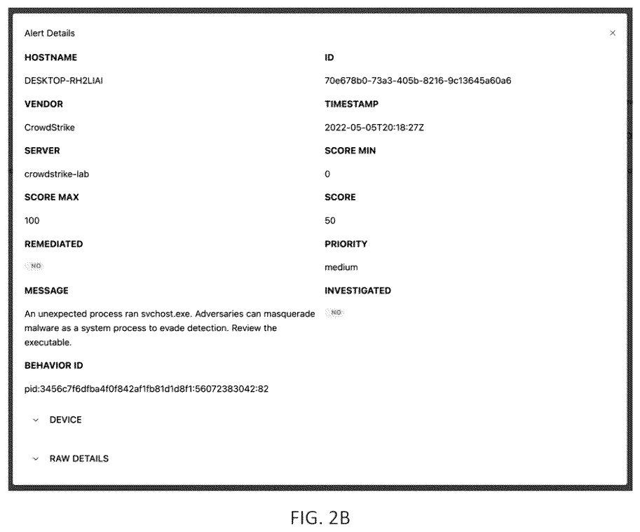

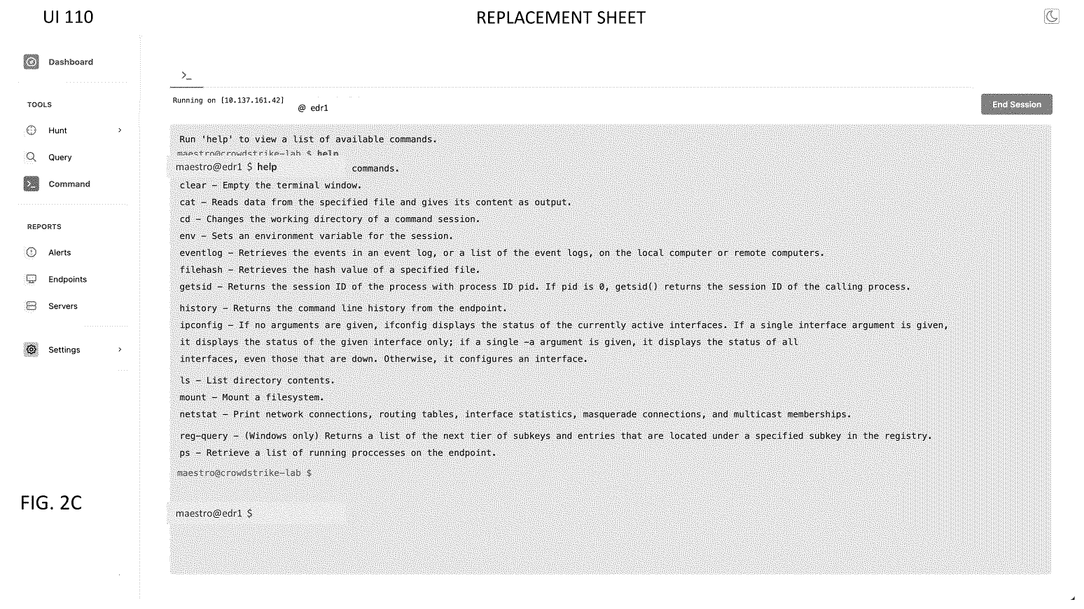

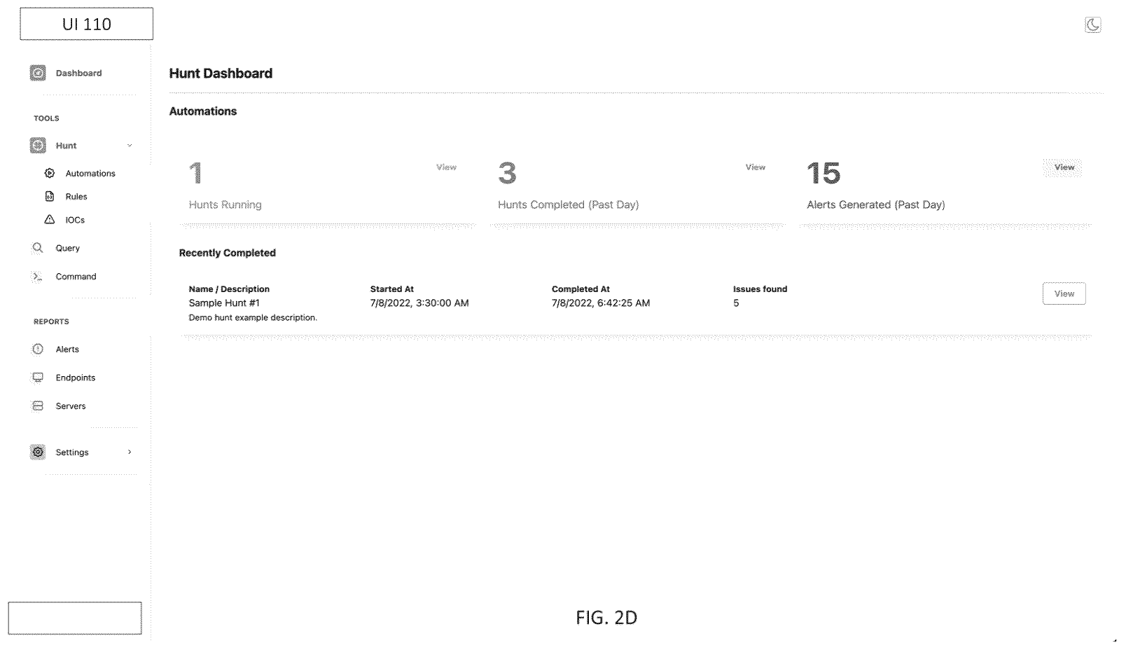

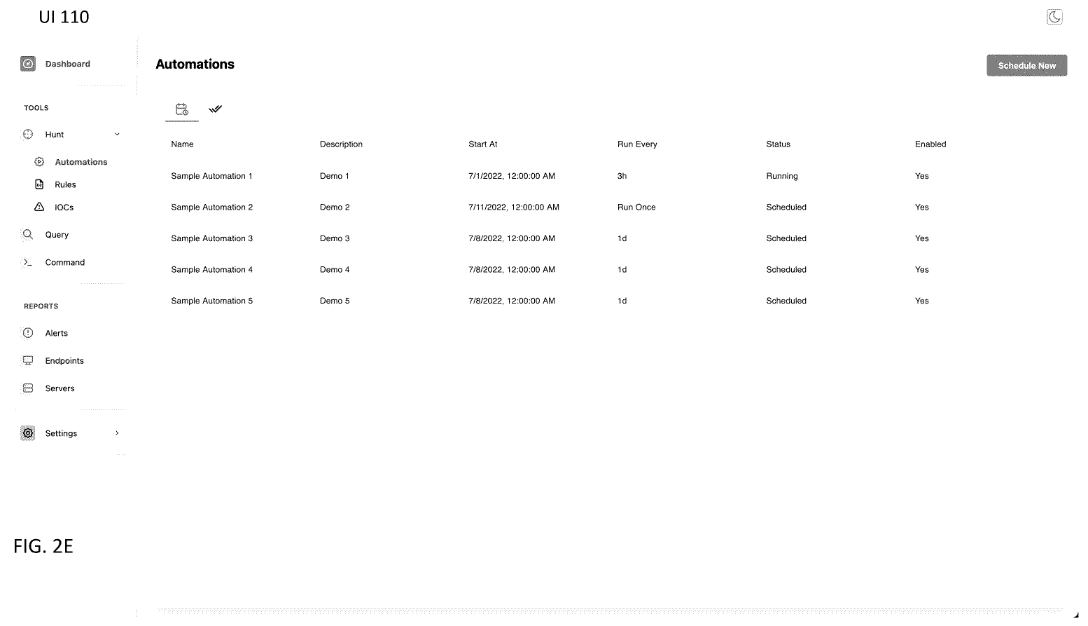

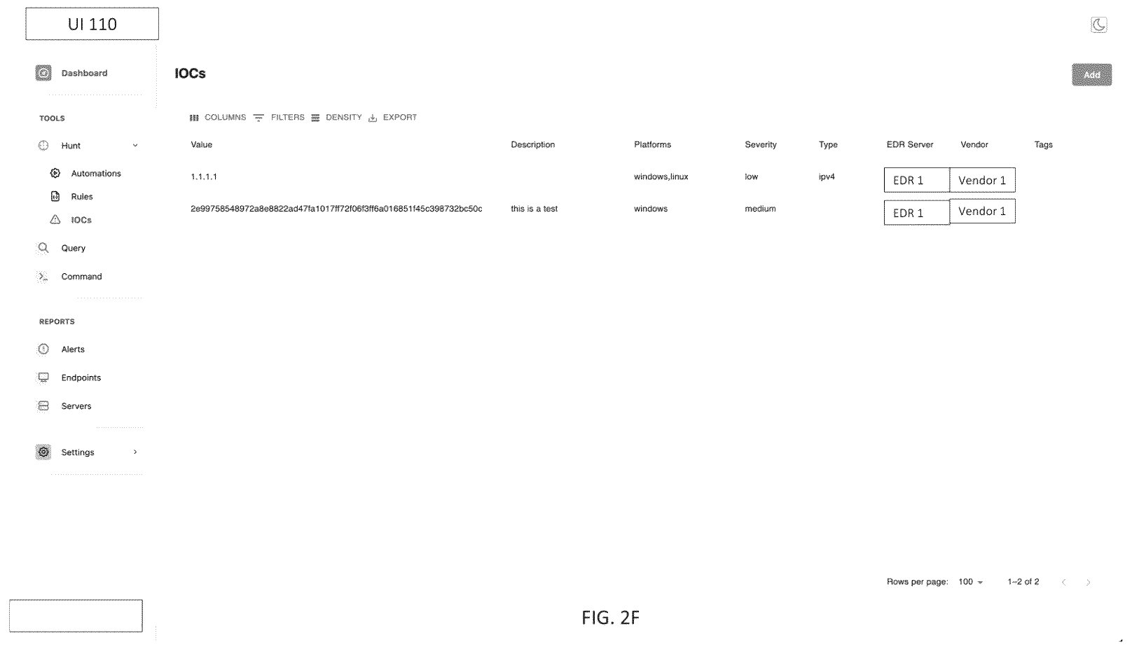

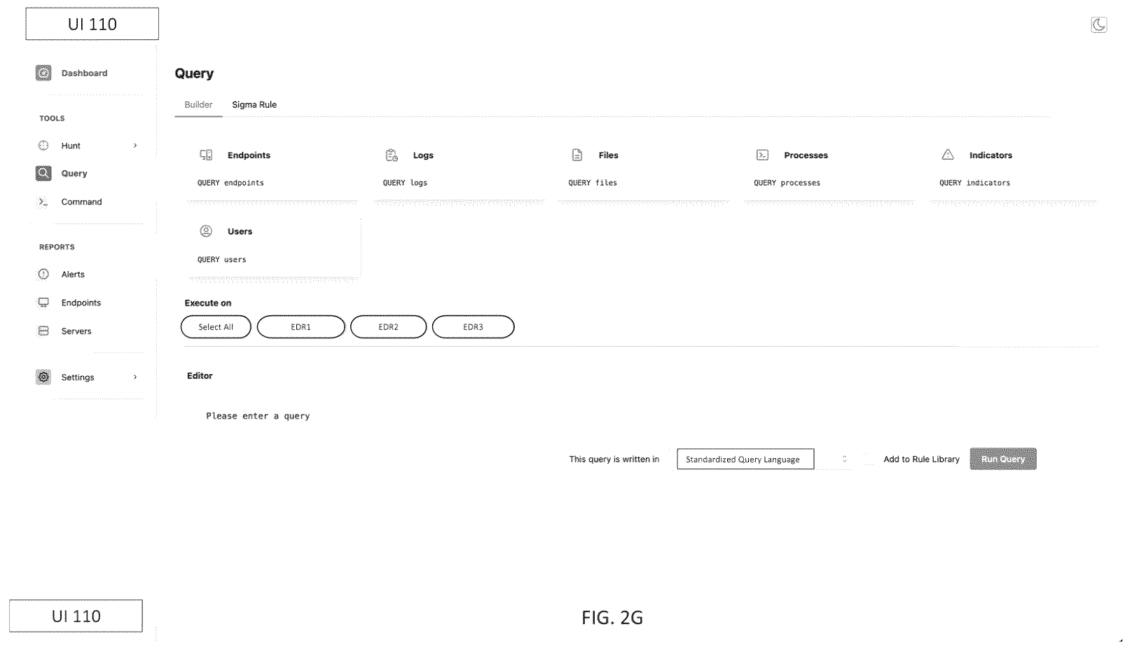

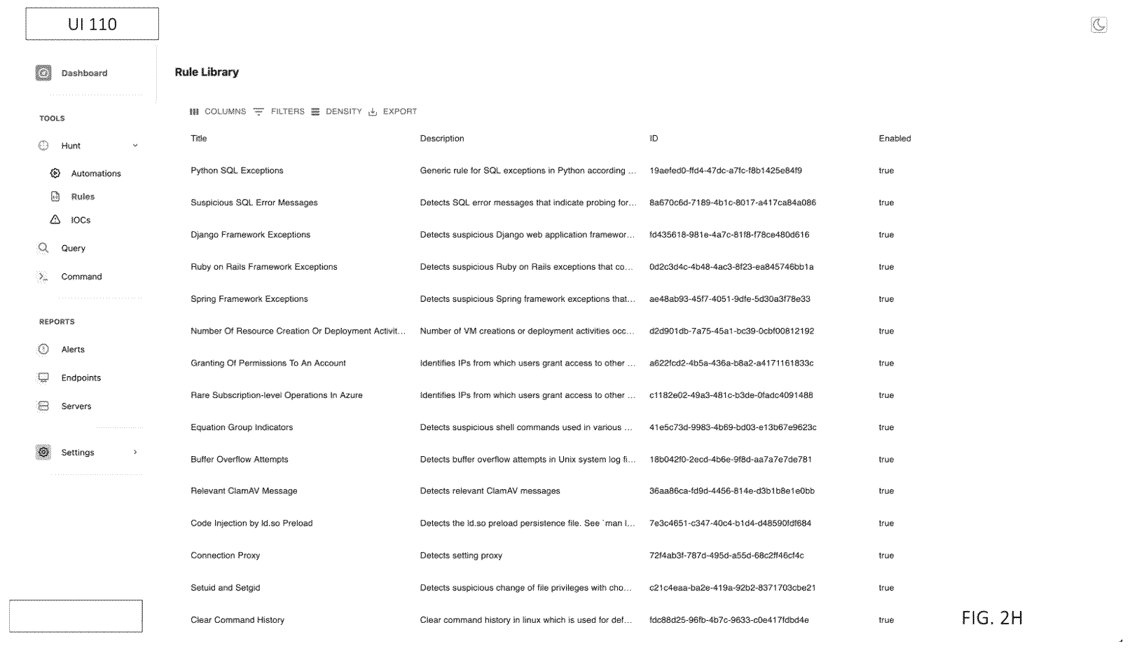

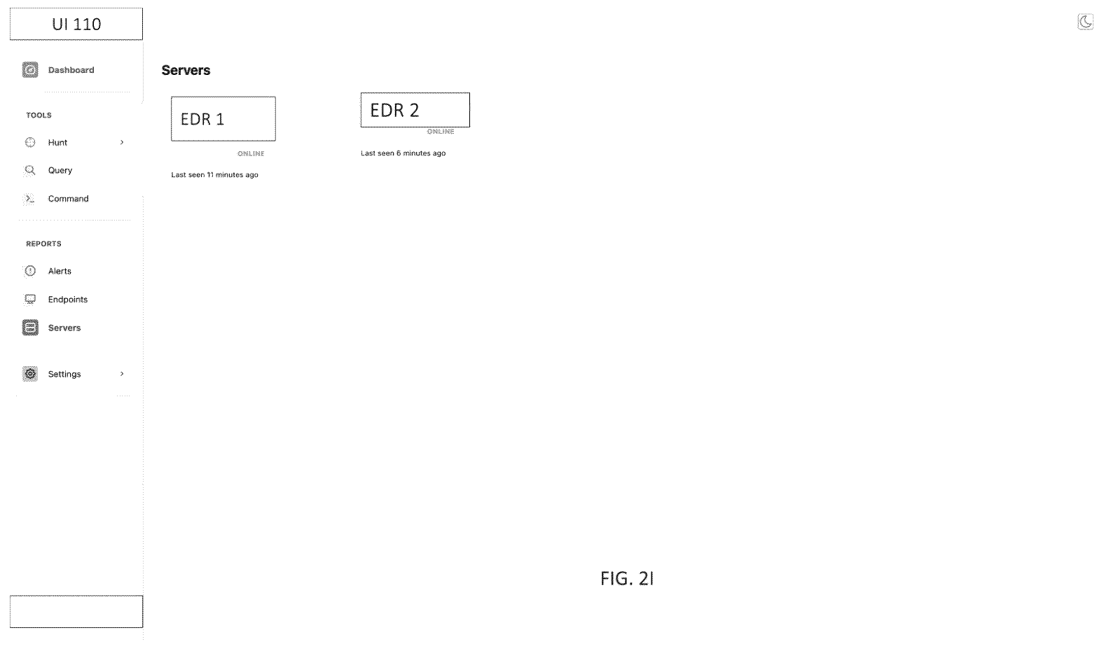

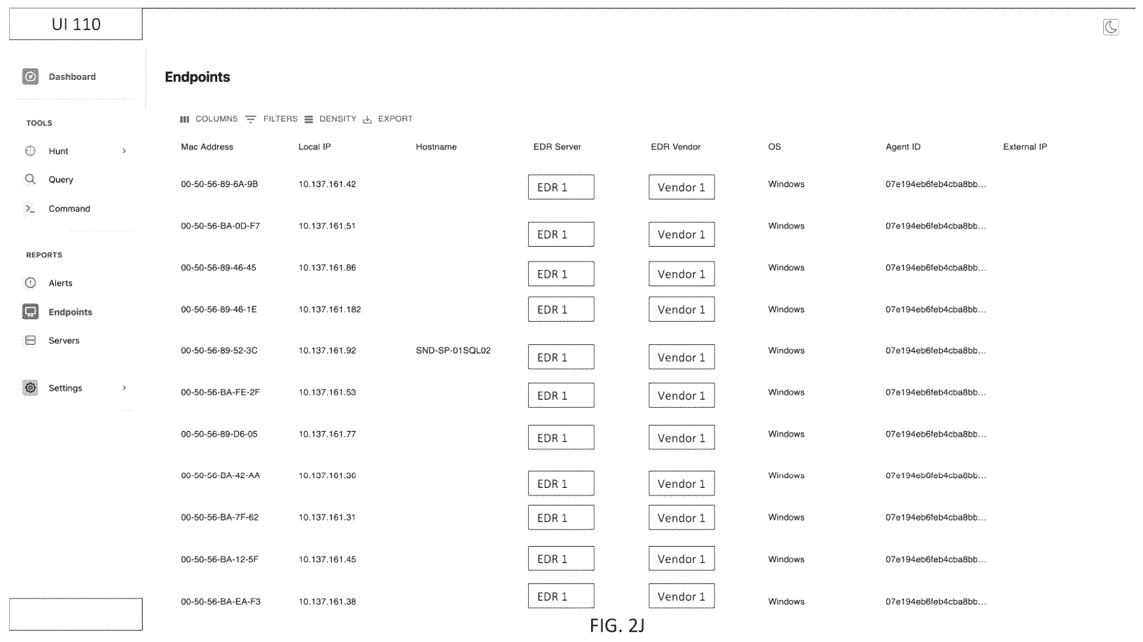

The UI 110 is a Command-and-Control system configured to interact with and manage the operations performed by the API 112. FIGS. 2A-2J illustrates an exemplary arrangement of the UI 110 in accordance with an exemplary embodiment. As shown in FIGS. 2A-2J, the UI 108 is unique in that it abstracts away layers of API calls to any one of the vendors associated with the EDR tool(s) 120 such that only a single click or command is needed (FIG. 2C). As a result, the UI 110 provides an intuitive, seamless experience to the user (e.g., analyst, agent) regardless of the number of configured EDR tools 120 and EDR servers 124 known to the system. As shown in FIG. 2G, the UI 110 allows users to query substantial amounts of data across all configured EDR tools 120 by offering multiple ways to configure the system. As already discussed, the UI 110 can be used in combination with user computing devices 122 (FIG. 2J). The user computing devices 122 can be configured to have integrated functions of an input device or be used in combination with one or more external (e.g., peripheral) input devices. The input device(s) allow data and information to be provided to the UI 110 for management and control of the EDR operations performed by the API 112. For example, the input device can include one or more of a physical or virtual keyboard, a touchpad, a mouse or stylus, or any other suitable input device as desired. The UI 110 can be configured to receive data and/or information from the user devices 122 through at least one of a keystroke command and button click command. According to an exemplary embodiment, the UI 110 can be configured to receive data and/or information using at least one of voice or image recognition technology, where the one or more input devices include an audio sensor (e.g., microphone) or image sensor (e.g., camera). Based on the command(s) received by the UI 110, the API 112 can be instructed to emulate a user command of a configured EDR tool 120 so that a desired security activity can be performed (FIGS. 2H and 21). For example, as shown in FIGS. 2D-2G, a user command can instruct the API 112 to generate at least one of an active hunt for malicious activity and a query for information associated with one or more of the plural EDR tools 120, vendors, and/or hosts, a server, an alert, and an indicator of compromise.

The detection engine 114 is configured to provide automated analysis, detection, and response to potential malicious activity outside of a Security Information and Event Management (SIEM) tool used by an organization. The detection engine 114 provides flexibility in its implementation as it can be deployed locally on each computing device in distributed network, in a centrally-located device (e.g., server) on-premises of the network, and/or in the cloud. Through its flexible implementation, the detection engine 114 standardizes signature detection of malicious activity across multiple EDR tools 120 using a common engine that is built to analyze data across various formats including an open-source format. According to an exemplary embodiment, the detection engine 114 can be configured for operation using an open-source Sigma rule format, which can provide the ability to scan any and all (e.g., approximately up to 100%) logs of an EDR tool 120 without being restricted by license costs or organizational team structures. As a result, the detection engine 114 can convert the streaming data received into the system into a common data format, analyze the converted streaming data, and generate an alert when malicious activity is detected. According to another exemplary embodiment, the generated alerts can be ranked according to at least one of the priority at which the malicious activity should be addressed and the severity of harm caused by the malicious activity.

The UI 110 can filter and sort the generated alerts based on at least one of priority and severity of the malicious activity. For example, the UI 110 can filter all alerts detected and known to the system so that only the most urgent are presented to the user or analyst (FIG. 2A). The UI 110 also can present and arrange the detected alerts in a variety of selectable and/or customizable formats. For example, as shown in FIG. 2A, the UI 110 can provide a summary or quick overview of the severity and contents of the most urgent alerts. According to another exemplary embodiment, the UI 110 can generate an interactive display of the filtered and sorted alerts, wherein each alert is an active or activatable link which when selected opens an additional window or graphic which presents additional information of an associated one of the plural EDR tools 120, vendors, and/or hosts which generated the alert (FIG. 2B). Through the UI 110, a user can navigate to deeper and more detailed levels of endpoint data with a single click, viewing the full details of an alert, or navigating a searchable, filterable, and sortable report of all alerts known to the system. Further, while actively investigating an endpoint for suspicious or malicious activity, the user can enter a single command to retrieve detailed data from the endpoint for further inspection.

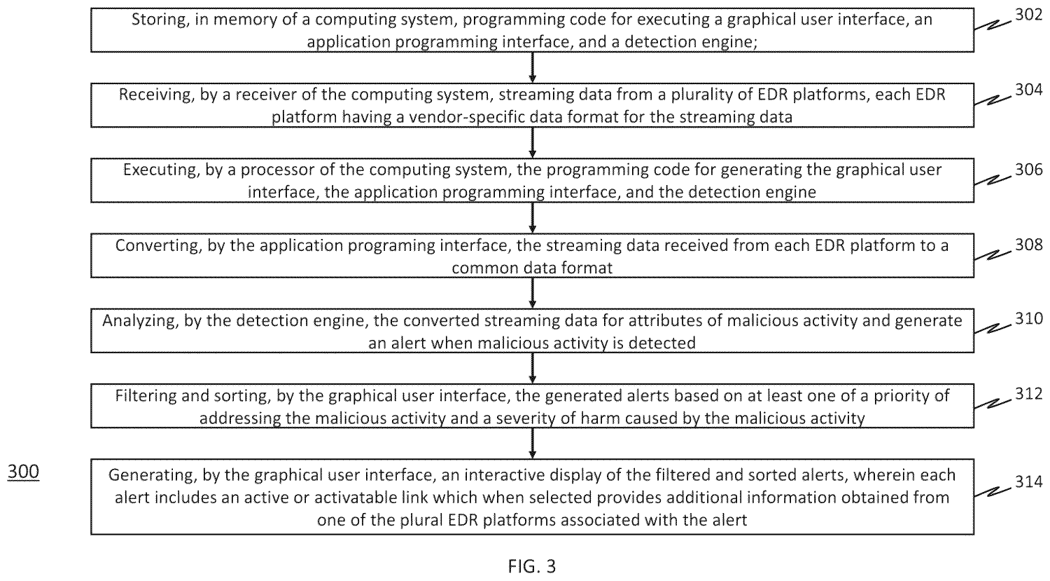

FIG. 3 illustrates a method 300 for end point detection and response in accordance with an exemplary embodiment of the present disclosure.

As shown in FIG. 3, program code for executing a UI 110, an application programming interface, and a detection engine is stored in memory 102 (Step 302). According to an exemplary embodiment, the program code can also include instructions for operating the EDRS unit 116 and the VCS unit 118. The receiver 104 of a processor 106 of a computing device receives streaming data from a plurality of EDR tools or platforms 120, each EDR platform 120 having a vendor-specific data format for the streaming data (Step 304). According to an exemplary embodiment, one or more of the EDR platforms can also be configured with a vendor-specific command and control structure. In step 306, the processor 106 of the computing system executes the program code for generating at least the UI 108, the API 110, and the detection engine 112. The processor 106 can further execute the program code for the EDRS unit 116 and the VCS unit 118. The API 112 converts the streaming data received from each EDR platform 120 to a common data format (Step 308) and the detection engine 114 analyzes the converted streaming data for attributes of malicious or suspicious activity and generates an alert when malicious or suspicious activity is detected (Step 310). The UI 110 filters and sorts the generated alerts based on at least one of a priority in addressing the malicious or suspicious activity and a severity of harm caused by the malicious or suspicious activity (Step 312). Next, the UI 110 generates an interactive display of the filtered and sorted alerts (Step 314), where each alert includes an active or activatable link which when selected provides additional information obtained from one of the plural EDR platforms 120 associated with the alert.

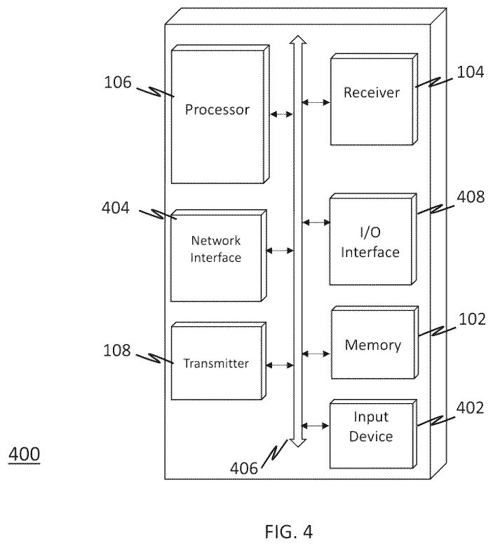

FIG. 4 illustrates a block diagram 400 of a hardware configuration of the computing system of FIG. 1 in accordance with an exemplary embodiment of the present disclosure. As shown in FIG. 4, includes the memory 102, the receiver 104, the processor 106, and the transmitter 108 which were previously discussed with regard to FIG. 1. The computing system 400 further includes one or more input devices 402, a network interface 404, an internal communication infrastructure 406, and an input/output (I/O) interface 408.

According to exemplary embodiments of the present disclosure, the one or more input devices 402 can be configured to allow a user to interact with the UI 110. As already discussed, the one or more input devices 402 can include one or more of a physical or virtual keyboard, a touchpad, a mouse or stylus, microphone, camera or any other suitable input device as desired. The receiver 104 can include a combination of hardware and software components configured to receive streaming data from one or more EDR tools 120. According to exemplary embodiments, the receiver 104 can include a hardware component such as an antenna, a network interface (e.g., an Ethernet card), a communications port, a PCMCIA slot and card, or any other suitable component or device as desired. The receiver 104 can be connected to other devices via a wired or wireless network or via a wired or wireless direct link or peer-to-peer connection without an intermediate device or access point. The hardware and software components of the receiver 104 can be configured to receive data (e.g., streaming data) according to one or more communication protocols and data formats. The receiver 104 can be configured to communicate over a network, such as enterprise network, which may include a local area network (LAN), a wide area network (WAN), a wireless network (e.g., Wi-Fi), a cellular communication network, a satellite network, the Internet, fiber optic cable, coaxial cable, infrared, radio frequency (RF), another suitable communication medium as desired, or any combination thereof. During a receive operation, the receiver 104 can be configured to identify parts of the received data via a header and parse the data signal and/or data packet into small frames (e.g., bytes, words) or segments for further processing at the processor 106. It should be understood that the device receiver 104 can be configured as an independent device or be have circuitry and components integrated with a network interface 404.

The processor 106 can be a special purpose or a general purpose processing device encoded with program code or software for performing the exemplary functions and/or features disclosed herein. According to exemplary embodiments of the present disclosure, the processor 106 can include a central processing unit (CPU). The processor 106 can be connected to the communications infrastructure 406 including a bus, message queue, or network, multi-core message-passing scheme, for communicating with other components of the system 100, such as the memory 102, the one or more input devices 402, the network interface 404, and the I/O interface 408. The processor 106 can include one or more processing devices such as a microprocessor, microcomputer, programmable logic unit or any other suitable hardware processing devices as desired.

The I/O interface 408 can be configured to receive the signal from the processing device 106 and generate an output suitable for a peripheral device via a direct wired or wireless link. The I/O interface 408 can include a combination of hardware and software for example, a processor, circuit card, or any other suitable hardware device encoded with program code, software, and/or firmware for communicating with a peripheral device such as a display device, printer, audio output device, or other suitable electronic device or output type as desired. The I/O interface 408 can also be configured to connect and/or communicate with or in combination with other hardware components provide the functionality of various types of integrated and/or peripheral input devices described herein.

The transmitter 108 can be configured to receive data from the device processor 106 and/or memory 102 and assemble the data into a data signal and/or data packets according to the specified communication protocol and data format of a peripheral device or remote device to which the data is to be sent. The device transmitter 108 can include any one or more of hardware and software components for generating and communicating the data signal over the internal communication infrastructure 406 and/or via a direct wired or wireless link to a peripheral or remote device. The transmitter 108 can be configured to transmit information according to one or more communication protocols and data formats as discussed in connection with the receiver 104. According to an exemplary embodiment, the receiver 104 and the transmitter 108 can be integrated into a single device and/or housing, or configured as separate and independent devices. According to another exemplary embodiment, the receiver 104 and the transmitter 108 can be configured shared circuitry and components and can be further integrated with the network interface 402.

According to exemplary embodiments described herein, the combination of the memory 102 and the processor 106 can store and/or execute computer program code for performing the specialized functions described herein. It should be understood that the program code can be stored on a non-transitory computer readable medium, such as the memory devices for the system 100 (e.g., computing device), which may be memory semiconductors (e.g., DRAMs, etc.) or other tangible and non-transitory means for providing software to the system 100. The computer programs (e.g., computer control logic) or software may be stored in memory 110 resident on/in the system 100. Such computer programs or software, when executed, may enable the system 100 to implement the present methods and exemplary embodiments discussed herein. Accordingly, such computer programs may represent controllers of the system 100. Where the present disclosure is implemented using software, the software may be stored in a computer program product or non-transitory computer readable medium and loaded into the system 100 using any one or combination of a removable storage drive, an interface for internal or external communication, and a hard disk drive, where applicable.

In the context of exemplary embodiments of the present disclosure, a processor can include one or more modules or engines configured to perform the functions of the exemplary embodiments described herein. Each of the modules or engines may be implemented using hardware and, in some instances, may also utilize software, such as corresponding to program code and/or programs stored in memory. In such instances, program code may be interpreted or compiled by the respective processor(s) (e.g., by a compiling module or engine) prior to execution. For example, the program code may be source code written in a programming language that is translated into a lower level language, such as assembly language or machine code, for execution by the one or more processors and/or any additional hardware components. The process of compiling may include the use of lexical analysis, preprocessing, parsing, semantic analysis, syntax-directed translation, code generation, code optimization, and any other techniques that may be suitable for translation of program code into a lower level language suitable for controlling the system 100 to perform the functions disclosed herein. It will be apparent to persons having skill in the relevant art that such processes result in the system 100 being a specially configured computing device uniquely programmed to perform the functions of the exemplary embodiments described herein.

It will be appreciated by those skilled in the art that the present invention can be embodied in other specific forms without departing from the spirit or essential characteristics thereof. The presently disclosed embodiments are therefore considered in all respects to be illustrative and not restrictive. The scope of the invention is indicated by the appended claims rather than the foregoing description and all changes that come within the meaning and range and equivalence thereof are intended to be embraced therein.

What is claimed is:

1. A system for end point detection and response (EDR), the system comprising:
memory that stores programming code for executing a graphical user interface, an application programming interface, and a detection engine;
a receiver configured to receive streaming data from plural EDR platforms, each EDR platform having a vendor-specific data format for the streaming data; and
a processor configured to:
execute the programming code for generating the graphical user interface, the application programming interface, and the detection engine;
convert, by the application programming interface, the streaming data received from each EDR platform to a common data format;
analyze, by the detection engine, the converted streaming data for attributes of malicious activity and generate an alert when malicious activity is detected;
filter and sort, by the graphical user interface, the generated alerts based on at least one of a priority of addressing the malicious activity and a severity of harm caused by the malicious activity; and
generate, by the graphical user interface, an interactive display of the filtered and sorted alerts, wherein each alert includes an active or activatable link which when selected provides additional information obtained from one of the plural EDR platforms associated with the alert.

2. The system of claim 1, further comprising:
one or more input devices configured to receive at least one of a keystroke command and a button click commands from a user interacting with the graphical user interface.

3. The system of claim 2, wherein the processor is configured to:
emulate, by the application programming interface, a user command of at least one of the plural EDR platforms according to the at least one keystroke command and button click command received through the one or more input devices.

4. The system of claim 3, wherein the processor is configured to:
create, by the application programming interface, at least one of an active hunt for malicious activity and a query for information associated with at the least one of the plural EDR platforms.

5. The system of claim 4, wherein the processor is configured to:
download, by the application programming interface, data associated with each EDR platform, the downloaded data relating to a vendor, a server, a host, an alert, and an indicator of compromise.

6. The system of claim 5, wherein the processor is configured to:
map, by the application programming interface, the streaming data and configuration files to each of a vendor address and vendor credentials associated with one of the plural EDR platforms.

7. The system of claim 5, wherein the processor is configured to:
modify, by the application programming interface, the indicator of compromise associated at least one of the plural EDR platforms.

8. The system of claim 1, wherein the processor is configured to:
convert, by the application programming interface, streaming data received in a first format associated with a first EDR platform to a second format associated with a second EDR platform.

9. The system of claim 8, wherein the processor is configured to:
convert, by the application programming interface, the streaming data in the first format of the first EDR platform to the common data format.

10. The system of claim 9, wherein the processor is configured to:
convert, by the application programming interface, the streaming data in the common data format to the second data format of the second EDR platform.

11. The system of claim 1, wherein the processor is configured to:
rank, by the detection engine, the generated alerts according to at least one of the priority and the severity of the malicious activity.

12. A method for end point detection and response (EDR), the method comprising:
storing, in memory of a computing system, programming code for executing a graphical user interface, an application programming interface, and a detection engine;
receiving, by a receiver of the computing system, streaming data from a plurality of EDR platforms, each EDR platform having a vendor-specific data format for the streaming data;
executing, by a processor of the computing system, the programming code for generating the graphical user interface, the application programming interface, and the detection engine;
converting, by the application programing interface, the streaming data received from each EDR platform to a common data format;
analyzing, by the detection engine, the converted streaming data for attributes of malicious activity and generate an alert when malicious activity is detected;
filtering and sorting, by the graphical user interface, the generated alerts based on at least one of a priority of addressing the malicious activity and a severity of harm caused by the malicious activity; and
generating, by the graphical user interface, an interactive display of the filtered and sorted alerts, wherein each alert includes an active or activatable link which when selected provides additional information obtained from one of the plural EDR platforms associated with the alert.

13. The method of claim 12, further comprising:
receiving, by one or more input devices, at least one of a keystroke command and a button click commands from a user for interacting with the graphical user interface.

14. The method of claim 13, further comprising:
emulating, by the application programming interface, a user command of at least one of the plural EDR platforms according to the at least one keystroke command and button click command received through the one or more input devices.

15. The method of claim 14, further comprising:
creating, by the application programming interface, at least one of an active hunt for malicious activity and a query for information associated with the at least one EDR platform.

16. The method of claim 15, further comprising:
downloading, by the application programming interface, data associated with the at least one EDR platform, the downloaded data relating to a vendor, a server, a host, an alert, and an indicator of compromise.

17. The method of claim 16, further comprising:
mapping, by the application programming interface, the streaming data and configuration files to each of a vendor address and vendor credentials of one of the plural EDR platforms.

18. The method of claim 16, further comprising:
modifying, by the application programming interface, the indicator of compromise associated at least one of the plural EDR platforms.

19. The method of claim 12, further comprising:
converting, by the application programming interface, streaming data received in a first format associated with a first EDR platform to a second format associated with a second EDR platform.

20. The method of claim 19, further comprising:
converting, by the application programming interface, the streaming data in the first format of the first EDR platform to the common data format.

21. The method of claim 20, further comprising:
converting, by the application programming interface, the streaming data in the common data format to the second data format of the second EDR platform.

22. The method of claim 12, further comprising:
ranking, by the detection engine, the generated alerts according to at least one of the priority and the severity of the malicious activity.

23. A computer readable medium storing program code for performing a method for end point detection and response (EDR), which when placed in communicable contact with a computing system the program code causing the computing system to perform operations comprising:
storing, in memory of a computing system, programming code for executing a graphical user interface, an application programming interface, and a detection engine;
receiving, by a receiver of the computing system, streaming data from plural EDR platforms, each EDR platform having a vendor-specific data format for the streaming data;
executing, by a processor of the computing system, the programming code for generating the graphical user interface, the application programming interface, and the detection engine;
converting, by the application programming interface, the streaming data received from each EDR platform to a common data format;
analyzing, by the detection engine, the converted streaming data for attributes of malicious activity and generate an alert when malicious activity is detected;
filtering and sorting, by the graphical user interface, the generated alerts based on at least one of a priority of addressing the malicious activity and a severity of harm caused by the malicious activity; and
generating, by the graphical user interface, an interactive display of the filtered and sorted alerts, wherein each alert includes an active or activatable link which when selected provides additional information obtained from one of the plural EDR platforms associated with the alert.
